(19) United States
(12) Patent Application Publication
(10) Pub. No.: US 2010/0062194 A1
(43) Pub. Date: Mar. 11, 2010

(54) ANTI-COUNTERFEITING METHODS AND DEVICES USING SUBSTANTIALLY TRANSPARENT FLUORESCENT MATERIALS

(76) Inventor: Xiao-Dong Sun, Fremont, CA (US)

Correspondence Address: SHERR & VAUGHN, PLLC, 620 HERNDON PARKWAY, SUITE 320, HERNDON, VA, 20170, US

(21) Appl. No.: 12/554,866

(22) Filed: Sep. 4, 2009

Related U.S. Application Data
(60) Provisional application No. 61/190,894, filed on Sep. 4, 2008.

(51) Int. Cl. B32B 5/16; C09K 11/77

(52) U.S. Cl. 428/29; 252/301.4 R; 977/773

(57) ABSTRACT

Embodiments relate to light emitting material integrated into the apparatus having an anti-counterfeit pattern. The light emitting material may be configured to emit visible light in response to absorption of ultraviolet light. The light emitting material may include a plurality of light emitting particles, with each of the plurality of light emitting particles having a diameter less than about 500 nanometers. Accordingly, in embodiments, the anti-counterfeit pattern may be invisible under ambient light. However, under ultraviolet light, the authenticity of a product may be identified by emission of light in the form of the anti-counterfeit pattern. In embodiments, the anti-counterfeit pattern may be in the form of a bar code, a computer readable code, and/or a symbol that verifies the authenticity of a product.

Priority is claimed to U.S. Provisional Patent Application No. 61/190,894, filed in the U.S. Patent and Trademark Office on Sep. 4, 2008, which is hereby incorporated by reference in it's entirety.

### BACKGROUND

Brands theft is a major issue that causes billions of dollars in loss of sales each year. Commercial brand names and logos (e.g. Coke, Nike, Apple, etc.) may printed onto the surfaces of products and/or the packaging materials. Brand names and logos may have a predetermined shape and color under ambient light that consumers identify with assuring them of the authenticity of the product. However, since printing using commercially available inks are readily available, products may be counterfeited through imitation of brand names and logos. Accordingly, there is a need to prevent the counterfeiting of products.

### SUMMARY

Embodiments relate to light emitting material integrated into the apparatus having an anti-counterfeit pattern. The light emitting material may be configured to emit visible light in response to absorption of ultraviolet light. The light emitting material may include a plurality of light emitting particles, with each of the plurality of light emitting particles having a diameter less than about 500 nanometers.

Accordingly, in embodiments, the anti-counterfeit pattern may be invisible under ambient light. However, under ultraviolet light, the authenticity of a product may be identified by emission of light in the fonn of the anti-counterfeit pattern. In embodiments, the anti-counterfeit pattern may be in the form of a bar code, a computer readable code, and/or a symbol that verifies the authenticity of a product.

### DRAWINGS

FIG. 1 is an example diagram of a consumer a product with packaging, in accordance with embodiments.

### DESCRIPTION

Embodiments relate to a method and/or apparatus that prevents identity theft that includes introduction of functional material ingredients into existing printing inks, which include fluorescent materials. Many fluorescent materials are either not transparent or have some body colors, which has an unintended negative affect on the appearance of printed commercial brands and logos under ambient light. To maintain the visual integrity of the commercial brand or logo identity without compromise, transparent fluorescent materials and/or substantially transparent fluorescent materials may be applied, in accordance with embodiments. Transparent fluorescent materials and substantially transparent materials are discussed in U.S. Pat. No. 6,986,581 (filed Nov. 3, 2004), which is hereby incorporated by reference in entirety.

In embodiments, fluorescent materials may include at least one of organic dyes, organic pigments, inorganic phosphors, organometallic dyes, semiconductor quantum dots, and/or other similar materials. Fluorescent materials may be prepared into substantially transparent form prior to being used in anti-counterfeiting applications. Fluorescent materials may be excited with ultraviolet light, visible light, and/or infrared light, and emit fluorescence light of visible to infrared. For example, fluorescent materials may absorb ultraviolet light and emit lower energy visible or infrared light. Alternatively, fluorescent materials may absorb visible light or infrared light and emit a lower wavelength infrared light.

In embodiments, fluorescent materials may be identified by a scanner using an ultraviolet, visible, and/or infrared light source to excite the fluorescent materials. The scanner may measure the converted fluorescent emission power and/or spectrum through an optical filter, grating, and/or other similar detection device.

Embodiments relate to utilization of down-conversion fluorescent materials, upconversion fluorescent materials that are in a substantially visual transparent form, whose excitation wavelength is longer than the emission wavelength. These materials may be used for anti-counterfeiting (AC) applications.

To make a substantially “transparent” fluorescent print or overcoat, the median or average particle sizes of these materials shall be less than the visible light wavelength, i.e. ˜400 nm. Some fluorescent dye molecules and quantum dots which can dissolve into ink formula will be naturally transparent, while inorganic phosphors and organic fluorescent pigments need to prepared into nano-particulates with sizes less than 400 nm. More specifically, the median or average particle sizes of these materials shall be less than 100 nm and larger than 0.5 nm. Embodiments relate to materials that are at least one of less than 500 nm, 400 nm, 300 nm, 200 nm, and/or 100 nm in diameter.

In embodiments, fluorescent materials with refractive index close to the ink medium or polymer resin of printing/coating formula may result in substantially transparent prints or overcoat as a AC feature (e.g. anti-counterfeit pattern and/or anti-counterfeit symbol) on a product. The median or average particle sizes of fluorescent materials in such case may be larger than 400 nm. The substantially transparent fluorescent ingredient may be either blended and/or dissolved in ink formula to make prints together, which present a brand or logo with both overt and covert features. The transparent ingredient may be over-coated onto existing prints, forming a covert transparent fluorescent image without affecting existing prints' appearances under ambient light.

In embodiments, an excitation light source and/or a scanner may be applied onto the brand name or logo prints with the transparent AC ingredients, to identify the genuine products with the fluorescent emission and/or spectral finger prints from counterfeits products without them.

In accordance with embodiments, to further enhance the level of security or difficulty to counterfeit, multiple substantially transparent fluorescent ingredients may be blended, in a certain ratio, with unique fluorescent “finger prints” such as spectral power distribution of emission, the color index, or the relative ratio of the peak emission from various fluorescent ingredients. By applying such ingredients, and applying a spectral scanner to characterize the fluorescent “finger prints” under optical excitation, genuine products with the desirable fluorescent fingerprints can be distinguished from counterfeits parts without it. In addition, the transparent fluorescent encryption can be applied over other security features without hiding them, to enhance existing security level.

Multiple layers of transparent fluorescent features can be overlaid or applied onto a product or package for enhanced AC measures. Multiplexing AC features can be obtained, with multiple fluorescent materials applied to a product or package together in various ratios of emission peak brightness under an excitation, detectable and resolvable by an optical or spectral scanner.

More complex transparent fluorescent AC features can be encrypted to the commercial products to further enhance the security level. Multiplexing AC features can be applied to individual product, with variable fluorescent identification in unit level that is virtually impossible to duplicate. For example, a covert fluorescent “bar code” can be printed out with a transparent fluorescent inks, which can be identified with an optical scanner under certain excitation light source; In addition, transparent fluorescents ingredients of different emission colors can be introduced, with different ratios of the ingredients, to encode and track different sets of products.

For example, two different sets of emission colors or spectrums may be used to form a binary code encryption with the transparent fluorescent materials that are printed onto a product and/or package, in accordance with embodiments. For example, ten transparent fluorescent ingredients with different emission colors or spectrums may represent codes of 0 to 9, and each product can have a unique set of transparent fluorescent “bar code” or fluorescent “color array” which is readable only to a special color or spectral scanner under certain excitation (e.g. UV) light. Unique invisible fluorescent bar codes may be printed onto each product or package, which may be detected by an optical scanner, and verified by a central server with all the fluorescent ID records of the genuine manufactured products. A spectral scanner under excitation light may identify the different colors of the encoded parts for tracking and identification purposes.

As another example, substantially transparent or invisible signs or graphics may be printed onto plastic film, papers, or textile substrates, which remains in natural original state under ambient light, but emit single or multiple colors under UV excitation light. Such printed substrates can be applied as new commercial wrapping or packaging materials With the novel anti-counterfeiting prints.

Given that the described anti-counterfeiting feature is substantially transparent and invisible, it can be combined with or overcoated onto other anti-counterfeiting objects, such as holographic labels and prints, RFID (radio frequency identification) tags and prints, microtext, 1-D or 2-D bar codes, embedded fiber, conventional fluorescent and upconversion phosphor prints, etc.

Example FIG. 2 is a photo that shows substantially invisible fluorescent prints on a transparent plastic substrate. Under ambient light the substrate remains in original state, under UV excitation light, the prints shows brilliant patterns of emissions, which can be used in anti-counterfeiting purpose.

FIG. 3 illustrates an example anti-counterfeiting feature on a CD/DVD under ambient light (left) and UV excitation light (right), respectively.

A variety of novel fluorescence materials may be utilized for anti-counterfeiting applications, in accordance with embodiments. A common property of these materials is that the size of the fluorescent particles is relatively small (e.g. between approximately 0.5 nm and 500 nm), in accordance with embodiments. Relatively small sizes of the fluorescent materials may minimize scattering effect that may adversely affect the looks of brands and logo prints. The following is a description on the elemental compositions of some examples of nano-fluorescent materials that may be applied in transparent fluorescent encryption applications and/or anti-counterfeiting applications. Applicable fluorescent materials may fall into four different categories: inorganic nano-meter sized phosphors; organic molecules and dyes; semiconductor based nano-particles; and organometallic molecules.

Inorganic or ceramic phosphors, including but not limited to metal oxides, metal halides, metal chalcoginides (e.g. metal sulfides), or their hybrids, such as metal oxo-halides, metal oxo-chalcoginides. The phosphor usually comprise of a host material and at least one type of doping fluorescent activator elements in the host crystals, such as rare earth or transitional metal cations (e.g. Eu, Tb, Ce, Er, Dy, Tm, Pr, Sm, Ho, Cr, Mn, Zn, Ir, Ru, Ag, Cu, etc). The host can be oxides such as metal aluminates, metal silicates, metal borates, metal phosphates, metal vanadates, etc. The host can also be metal halides (e.g. fluorides, chlorides), metal chalcoginides (e.g. sulfides), and their hybrids with metal oxides. There are also phosphors without other doping elements, such as metal tungstates, ZnO, etc. These inorganic phosphors have found wide applications in solid state lighting and fluorescent lamps and displays. These materials prepared in substantially transparent nano-crystalline forms can covert shorter wavelength photon (e.g. UV and visible/IR) into longer wavelength visible or IR light. They may also be light prepared into substantially transparent nano-crystalline form and upconvert IR to visible or higher energy IR light for the disclosed AC applications.

Organic dyes and small organic molecules, and fluorescent organic polymers. They typically contain unsaturated chemical bonds, conjugated bonds or aromatic parts that interact with light. These can also be used to convert shorter wavelength photon (e.g. UV and visible) into longer wavelength visible or IR light.

Semiconductor nano-particles, such as II-VI or III-V compound semiconductors, e.g. fluorescent quantum dots (QD). The nanoparticle can be either a homogeneous nano-crystal, or comprises of shells. For example, it includes a “core” of one or more first semiconductor materials, and may be surrounded by a “shell” of a second semiconductor material. The core and/or the shell can be a semiconductor material including, but not limited to, those of the group II-VI (ZnS, ZnSe, ZnTe, CdS, CdSe, CdTe, HgS, HgSe, HgTe, MgS, MgSe, MgTe, CaS, CaSe, CaTe, SrS, SrSe, SrTe, BaS, BaSe, BaTe, and the like) and III-V (GaN, GaP, GaAs, GaSb, InN, InP, InAs, InSb, and the like) and IV (Ge, Si, and the like) materials, and an alloy or a mixture thereof Some atoms (e.g. Mn, Eu, etc) may also be doped into a semiconductor QD host, and exhibit fluorescent emissions from the atoms. The typical particle site of such QD are under 10 nm.

Organometallic molecules. The molecules include at least a metal center such as rare earth elements (e.g. Eu, Tb, Ce, Er, Dy, Tm, Pr, Sm, Ho) and transitional metal elements such as Cr, Mn, Zn, Ir, Ru, V, and main group elements such as B, Al, Ga, etc. The metal elements are chemically bonded to organic groups such as chelates or complexing molecules to prevent the quenching of the fluorescence from the hosts or solvents.

The nano-particulate fluorescent ingredients described above may be mixed with various types of polymeric resins to prepare a transparent fluorescent encryption ink or label on an article. The typical plastics applied in this invention are organic and polymeric solids which are also substantially transparent. Embodiments relate to polymers including thermosets, thermoplastics, elastomers, and/or inorganics. Certain polymeric alloys, defined as two or more miscible or partially miscible polymers, and blends, defined as discrete non-miscible phases, are also preferred. Specific examples of thermosets and elastomers include polyesters, gels. polyurethanes, Polyvinyl Butyral (PVB), ethylene vinyl acetate (EVA), natural rubber, synthetic rubber, epoxy, phenolic, polyamides, and silicones. Specific examples of thermoplastics include polyacetal, polyacrylic, acrylonitrile-butadiene-styrene, polycarbonates, polystyrenes, polyethylene,styrene acrylonitrile, polypropylenes, polyethylene terephthalate, polybutylene terephthalate, nylons (6, 6/6, 6/10, 6/12, 11 or 12), polyamide-imides, polyarylates, thermoplastic olefins (i.e., polypropylene/impact modifiers such as ethylene, propylene and rubber), thermoplastic elastomers, polyarylsulfone, polyethersulfone, polyphenylene sulfide, polyvinyl chloride, chlorinated polyvinyl chloride, polysulfone, polyetherimide, polytetrafluoro ethylene, fluorinated ethylene propylene, perfluoroalkoxy, polychlorotrifluoro ethylene, ethylene tetrafluoro ethylene, polyvinylidene fluoride, polyvinyl fluoride, polyctherketone, polyether etherketone and polyether ketone ether ketone ketone. Specific examples of alloys and blends include acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, polysulfone/acrylonitrile-butadiene-styrene, polycarbonate/thermoplastic urethane, polycarbonate/polyethylene terephthalate, thermoplastic elastomer alloys, nylon/elastomers, polyester/elastomers, polyethylene terephthalate/polybutyl terephthalate, acetal/elastomer, styrene-maleic-anhydride/acrylonitrile-butadiene-styrene, polyether etherketone/polyethersulfone, polyethylene/nylon and polyethylene/acetal. Specific examples of inorganic polymers include phosphorus based compounds and silicones. The previous mentioned plastics can also be combined or laminated together to form the base plastic optical media.

In embodiments, the applicable substrates may include (hut are not limited to) printing media, any types of labels, plastic or metal embossments on the products, fabrics, and other similar substrates. The application of the fluorescent coatings may be done by any methods that are suitable for wet coatings, such as roll, brush, spray, printing (inkjet, gravure, flexographic, offset, screen), curtain coating, slot die, hot melt, stamping, dipping, dying, spinning, etc. The printing ink or coating solvents can be organic based (e.g. Ketone, Alcohol, Toluene, etc) or more environmentally friendly water based.

Embodiments relate to various applications of novel fluorescent materials that are substantially transparent and/or invisible that are integrated into and/or onto merchandize, for the purposes of product decorating and/or anti-counterfeiting. Embodiments relate to various ways to integrate a transparent fluorescent layer and/or a substantially transparent fluorescent layer onto a merchandize. In embodiments, the particle sizes of the fluorescent materials on the merchandize may be less than the visible light wavelength (e.g. less than ˜400 nm or less than ˜500 nm) to make them substantially transparent. In embodiments, the refractive index of the polymer (resin) may be close to the fluorescent materials to make the layer substantially transparent.

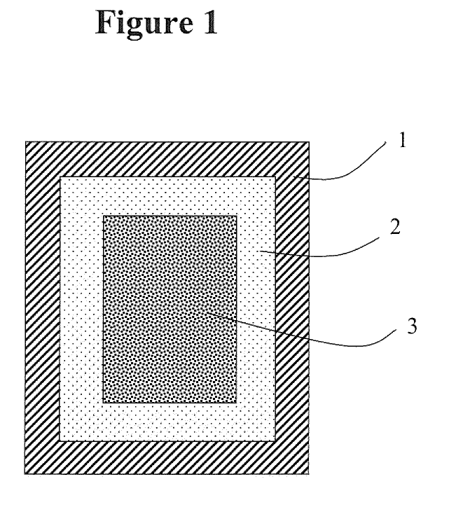

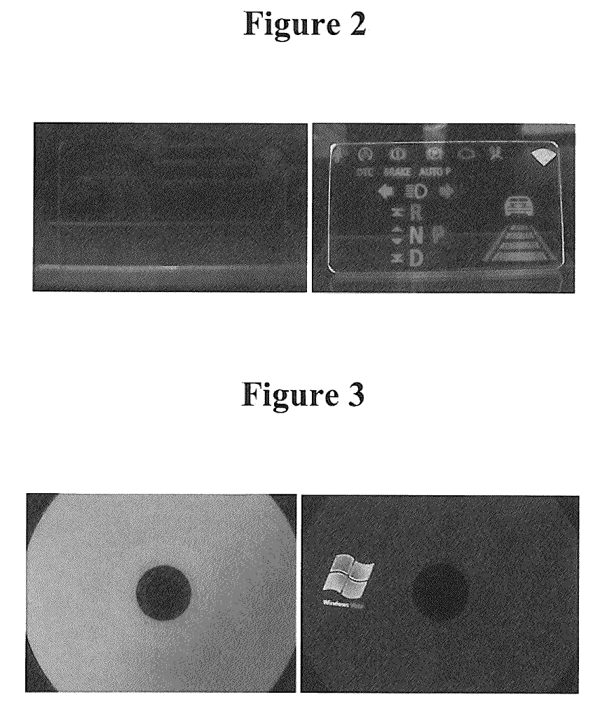

Example FIG. 1 illustrates ways to apply a substantially transparent fluorescent layer, in accordance with embodiments. Product merchandise may generally have the a wrapping and/or packaging layer 1, a container layer 2, and/or a product layer 3. There may be labels and/or prints applied onto these layers, which may contain the product brand name, logo, and/or other product information. FIG. 1 illustrates three layers of an example merchandise product. For example, for liquid type products such as a bottle of wine, layer 1 may include plastic wraps on bottle or lids, layer 2 may be a the package box (including the bottle with lids and any accessories), and layer 3 may be the wine. The example on wine can also be extended to other liquid or gel types of products that uses bottles, including waters and soft drinks, cosmetic and beauty products (e.g. lotion); hygiene products (e.g. shampoo, toothpaste), canned food, etc.

For solid types of products, such as a pack of cigarettes, layer 1 may include the packaging box or the plastic wrap on the pack of cigarette; layer 2 may include the container package (hard or soft) of the collection of individual cigarettes (mostly 20 units); and layer 3 may include all individual cigarettes. For medical drugs, layer 1 may include plastic wraps and/or package box, layer 2 may include bottles or blister package, and layer 3 may be the drug pills. Such examples of layers may also be extended to other solid types of products, including food, automobile parts, clothes and shoes, consumer electronics, etc.

The product labels or prints are mostly applied to the layer 1 and layer 2; although in some cases they are also applied directly to the product layer 3 itself (e.g. cigars). Substantially transparent fluorescent materials (STFM) may be applied to at least one of the three layers of the product, either directly, or onto the corresponding labels, in accordance with embodiments.

For example, in accordance with embodiments, the STFM may be prepared into a substantially transparent fluorescent film form, which shrink to heat and can be used as the special light emitting packaging and/or wrapping materials on layer 1 and/or layer 2, which include for example, the wine bottle lid or cigarettes pack. It may he substantially transparent, hence it does not affect the product/package looks; it is also light-emitting under excitation, which serves as brand enhancement decorations and/or anti-counterfeiting purposes. Since the STFM are transparent, hence multiple layers or mixture of STFM can be applied together onto a product/package layers. When there is no or little cross-excitation, the multiple STFM layer may exhibit multiple distinctive emitting colors from excitation sources with different wavelengths.

As another example, the STFM may be integrated into a substantially transparent paint or ink formula and applied to three layers of products/packages or corresponding labels, by painting. coating or printing. There are various coating/printing methods that can be used in this regards.

As another example, the STFM may be blended with non-transparent inks or paints, to introduce the lighting emitting function without affecting existing product packing/labeling process. In embodiments STFM may be blended and/or dissolved in golden inks widely used in the packing of cigarettes and wines. In another specific application, STFM can be applied to the golden strip that is commonly used to takeout the plastic wrapping of cigarettes. The subject remains the natural golden appearance under ambient light, while emitting non-golden light under excitation.

As another example, STFM may be applied onto the brand or logo of the labels or prints, or it can be printed into a substantially transparent brand or logo image onto at least one of the corresponding brand product layers. Under excitation, the STFM may emit light of the same or different colors from the background colors under ambient light where it is applied to. The light emitting brand or logo will enhance the brand image and can serve as anti-counterfeiting function simultaneously.

The foregoing embodiments (e.g. light emitting material integrated in the form of an anti-counterfeit symbol) and advantages are merely examples and are not to be construed as limiting the appended claims. The above teachings can be applied to other apparatuses and methods, as would be appreciated by one of ordinary skill in the art. Many alternatives, modifications, and variations will be apparent to those skilled in the art.

What is claimed is:

1. An apparatus comprising light emitting material integrated into the apparatus having an substantially transparent anti-counterfeit pattern, wherein:
the light emitting material is configured to emit visible light in response to absorption of ultraviolet light;
the light emitting material comprises a plurality of light emitting particles; and
each of the plurality of light emitting particles has a diameter less than about 500 nanometers.

2. The apparatus of claim 1, wherein the ultraviolet light has a wavelength greater than 320 nanometers.

3. The apparatus of claim 1, wherein the light emitting material is fluorescent material.

4. The apparatus of claim 1, wherein each of the plurality of light emitting particles has a diameter less than about 400 nanometers.

5. The apparatus of claim 4, wherein each of the plurality of light emitting particles has a diameter less than about 300 nanometers.

6. The apparatus of claim 5, wherein each of the plurality of light emitting particles has a diameter less than about 200 nanometers.

7. The apparatus of claim 6, wherein each of the plurality of light emitting particles has a diameter less than about 100 nanometers.

8. The apparatus of claim 1, wherein the light emitting material comprises:
a first material configured to emit a first visible color in response to absorption of a first bandwidth of ultraviolet light; and
a second material configured to emit a second visible color in response to absorption of a second bandwidth of ultraviolet light, wherein the second visible color is different from the first visible color.

9. The apparatus of claim 8, wherein the first bandwidth of ultraviolet light and the second bandwidth of ultraviolet light are different.

10. The apparatus of claim 8, wherein the first bandwidth of ultraviolet light and the second bandwidth of ultraviolet light are within the range of about 0 nanometers to about 480 nanometers.

11. The apparatus of claim 10, wherein the first bandwidth of ultraviolet light and the second bandwidth of ultraviolet light are within the range of about 190 nanometers to about 460 nanometers.

12. The apparatus of claim 11, wherein the first bandwidth of ultraviolet light and the second bandwidth of ultraviolet light are within the range of about 300 nanometers to about 420 nanometers.

13. The apparatus of claim 8, wherein the light emitting material comprises a third material configured to emit a third visible color in response to absorption of a third bandwidth of ultraviolet light, wherein the third visible color is different from the first visible color and the second visible color.

14. The apparatus of claim 13, wherein the first visible color, the second visible color, and the third visible color are primary colors.

15. The apparatus of claim 1, wherein the anti-counterfeit pattern is integrated into a product.

16. The apparatus of claim 1, wherein the anti-counterfeit pattern is integrated into the packaging of the product.

17. The apparatus of claim 1, wherein the anti-counterfeit pattern is invisible under ambient light.

18. The apparatus of claim 17, wherein the anti-counterfeit pattern overlays a visible pattern.

19. The apparatus of claim 18, wherein the anti-counterfeit pattern is a logo.

20. The apparatus of claim 18, wherein the anti-counterfeit pattern is at least one of a bar code, a computer readable code, and a symbol that verifies the authenticity of a product.
